(19) United States
(12) Patent Application Publication
(10) Pub. No.: US 2013/0301051 A1
(43) Pub. Date: Nov. 14, 2013

(54) SCATTERING LIGHT SOURCE MULTI-WAVELENGTH PHOTOMETER

(71) Applicants: Andrew Pogosyan, Madison, WI (US); Sergey I. Pogosyan, Moscow (RU); Sergey V. Galchuk, Moscow Region (RU)

(72) Inventors: Andrew Pogosyan, Madison, WI (US); Sergey I. Pogosyan, Moscow (RU); Sergey V. Galchuk, Moscow Region (RU)

(21) Appl. No.: 13/813,241

(22) PCT Filed: Jun. 17, 2011
(86) PCT No.: PCT/US11/40827

§ 371 Date: May 20, 2013

Related U.S. Application Data
(60) Provisional application No. 61/356,241, filed on Jun. 18, 2010.

(51) Int. Cl. G01N 21/01; G01N 21/59; G01N 21/55; G01N 21/64

(52) U.S. Cl. CPC G01N 21/01; G01N 21/64; G01N 21/59; G01N 21/55
USPC 356/432; 250/578.1; 250/459.1; 356/445

(57) ABSTRACT

The present invention relates to a scattering light source photometer. In particular, the present invention relates to a portable, low cost, multi-wavelength photometer and methods for its use.

This application claims priority to provisional application 61/356,241, filed Jun. 18, 2010, which is herein incorporated by reference in its entirety.

### FIELD OF THE INVENTION

The present invention relates to a scattering light source photometer. In particular, the present invention relates to a portable, low cost, multi-wavelength photometer and methods for its use.

### BACKGROUND OF THE INVENTION

Spectral analysis is a basic measuring method of properties, chemical or physical as well as others, in a fluid with substances as suspension and/or solution (e.g., absorbance/transmittance, turbidity, polarization or fluorescence measurements) or on a surface (e.g., reflectance or fluorescence measurements). Spectral photometry of light absorption in chosen ranges of wave lengths is a well established standard method for determination of substances or concentrations of substances in a fluid, suspension or on a surface and/or the actual condition of the substances at the time of measurement. The method is commonly used within medical, environmental, chemical and other technologies. Existing photometers are expensive and have moving parts that can break and are thus not well suited to field or portable use. What is needed is a low cost, multi-wavelength photometer that is durable and portable.

### DESCRIPTION OF THE DRAWINGS

FIG. 1 shows an overview of the optical scheme of a photometer of embodiments of the present invention.

FIG. 2 shows an overview of an exemplary optical scheme used in photometers of embodiments of the present invention.

FIG. 3 shows an overview of a further exemplary optical scheme used in photometers of embodiments of the present invention.

FIG. 4 shows absorbance curves of a didymium filter at 6 different wavelengths.

FIG. 5 shows a schematic of a double beam photometer of embodiments of the present invention.

FIG. 6 shows a photograph of a photometer of embodiments of the present invention.

FIG. 7 shows a photograph of an exemplary system of embodiments of the present invention.

### SUMMARY OF THE INVENTION

The present invention relates to a scattering light source photometer. In particular, the present invention relates to a portable, low cost, multi-wavelength photometer and methods for its use.

For example, in some embodiments, the present invention provides a photometer, comprising: a plurality (e.g., 2 or more, 6 or more 12 or more, 24 or more, 48 or more, 100 or more, etc.) of light sources (e.g., light emitting diodes (LEDs), laser diodes or lamps); a light scattering material (e.g., light back-scattering or light forward-scattering material) in the path of light emitted from the light source; a focusing component in the path of light scattered from the light scattering material; a sample holding component in the path of light focused by the focusing device; and a detector configured to detect light that has interacted with and been altered by the sample. In some embodiments, the photometer further comprises an analysis component comprising a computer processor and computer display screen. In some embodiments, the plurality of LEDs or laser diodes comprises at least two LEDs or laser diodes, wherein each of the at least two LEDs or laser diodes emits light of a different wavelength. In some embodiments, the plurality of LEDs or laser diodes comprises at least six (e.g., 12, 24, 48, etc.), wherein each of the at least six emits light of a different wavelength. In some embodiments, diodes are configured to operate in a pulse mode (e.g., multiple (e.g., 10, 20, 30, 40 50 or more cycles) of “ON and “OFF”, wherein each cycle is from 0.1 to 100 (e.g., 1, 2, 3, 4, 5, 6, 7, 8, 9, or 10 ms). In some embodiments, the light back scattering material is made out of or coated with a material with a reflectance of at least 99%. In some embodiments, the light forward-scattering material breaks up and distributes light evenly (e.g., at or near Lambertian distribution). In some embodiments, the focusing component is a collimating lens. In some embodiments, the sample holding component is a cuvette or solid sample holder. In some embodiments, the detector is a photo diode, a diode array, or a photomultiplier. In some embodiments, the detector is placed at an angle of from greater than 0 to 180 degrees relative to light emitted from the light source. In some embodiments, the photometer comprises two or more detectors and optical pathways. Embodiments of the present invention further provide systems, kits, devices, etc. comprising the photometers described herein, along with any additional components necessary, sufficient or useful for using the photometers for the analysis of samples.

Further embodiments of the present invention provide a method, comprising analyzing a sample with a photometer as described herein with a sample under conditions such that the transmittance, reflectivity, turbidity or fluorescence of the sample is measured by the photometer. In some embodiments, the sample is, for example, a chemical sample, an environmental sample or a biological sample. In some embodiments, the sample is a liquid, a solid or a suspension.

Additional embodiments are described herein.

### Definitions

As used herein, the term “sample” is used in its broadest sense. In one sense, it is meant to include a specimen or culture obtained from any source, as well as biological, chemical, pharmaceutical and environmental samples. Biological samples may be obtained from animals (including humans) and encompass fluids, solids, tissues, and gases. Biological samples include blood products, such as plasma, serum and the like. Environmental samples include environmental material such as surface matter, soil, water, crystals and industrial samples. In some embodiments, samples are solutions, suspensions, solids or powders. Such examples are not however to be construed as limiting the sample types applicable to the present invention.

As used herein, the term “light emitting diode” (LED) refers to a semiconductor light source. LEDs generally emit light at one particular wavelength. The present invention is not limited to LEDs that emit light of a particular wavelength. In some embodiments, LEDs that emit light in the visible, ultraviolet or infrared spectrum are utilized. In some embodiments of the present invention, photometers utilize LEDs as light sources.

As used herein, the term “laser diode” refers to a laser where the active medium is a semiconductor. Laser diodes generally emit light at one particular wavelength. In some embodiments, laser diodes that emit light in the visible, ultraviolet or infrared spectrum are utilized. In some embodiments of the present invention, photometers utilize laser diodes as light sources.

As used herein, the term “lamp” refers to any light source that emits light over a broad spectrum of wavelengths (e.g., a spectrum of greater than 40 nm, greater than 100 nm, or greater than 400 nm). In some embodiments, lamps are “incandescent light bulbs” or “fluorescent light bulbs.” As used herein, the terms “incandescent light bulb” or “incandescent lamp” refer to a source of light that works by incandescence. In some embodiments, an electric current passes through a thin filament, heating it to a temperature that produces light. In some embodiments, the filament is enclosed in a glass bulb contains either a vacuum or an inert gas to prevent oxidation of the hot filament. As used herein, the terms “fluorescent lamp” or “fluorescent light bulb” refer to a gas-discharge lamp that uses electricity to excite mercury vapor. The excited mercury atoms produce short-wave ultraviolet light that then causes a phosphor to fluoresce.

As used herein, the term “light scattering” refers to scattering of light or other electromagnetic radiation. In some embodiments, light scattering is the deflection of rays in random directions by irregularities in the propagation medium, or in a surface or interface between two media. In some embodiments, “light scattering” is “back-scattering” or “forward-scattering.” As used herein, the term “back-scattering” refers to the scattering of light diffused backwards from a non-transparent material. As used herein, the term “forward-scattering” refers to the scattering of light that gets diffused while passing through a transparent film.

As used herein, the term “Nephelometry” refers to the measurement of turbidity (e.g., scattering of a light beam by particles in a suspension). In some embodiments, nephelometry is performed using an instrument called a nephelometer with the detector setup to the side of the light beam. More light reaches the detector if there are lots of small particles scattering the source beam than if there are few. In some embodiments, the units of turbidity from a calibrated nephelometer are called Nephelometric Turbidity Units (NTU)

As used herein, the term “photodiode” refers to a photodetector capable of converting light into either current or voltage. In some embodiments, photodiodes are used to detect light passing through a photometer of embodiments of the present invention. As used herein, the term “diode array” refers to an array of photodiodes.

As used herein, the term “photomultiplier” refers to vacuum phototubes that are detectors of light in the ultraviolet, visible, and near-infrared ranges of the electromagnetic spectrum. Photomultipliers detect multiply the current produced by incident light by as much as 100 million times, in multiple dynode stages. In some embodiments, photomultiplier tubes are used to detect light passing through a photometer of embodiments of the present invention.

### DETAILED DESCRIPTION OF THE INVENTION

The present invention relates to a scattering light source photometer. In particular, the present invention relates to a portable, low cost, multi-wavelength photometer and methods for its use.

Methods of adsorption, optical density and reflection determination in certain region of optical spectrum became are a powerful tool for the control of the technological processes and in laboratory practice. Incandescent lamps, gas emission lamps and light emitting diodes are widely used as a source of light emission in methods like photometry, fluorometry, nephelometry, turbidimetry, polarimetry, densitometry and others. The accuracy and precision of all these methods is based on the reproducibility and accuracy of the parallel emission rays' geometry in all applied spectral bands. Due to that fact change of optical emission sources in analyzers is usually done by a mechanical system, which switches position of mirrors, optical filters, or light emitting diodes. Mechanical systems, especially in portable instruments, are not reliable and reproducible, and require periodic costly adjustments.

Some analyzers utilize broadband optical emission sources, for example incandescent lamps. In this case several spectral bands are analyzed, after separation, for example, by a system of partially transmitting mirrors aligned at 45 degree angle to the emission light. This system requires the usage of multiple detectors, each one of which analyzes only the specific narrowband spectrum range. Utilization of a multidetection system makes the electronic part of the system significantly more complex and less reliable. The presence of several detectors and complex electronic part of an analyzer makes it expensive.

Accordingly, in some embodiments, the present invention provides a diffusion light source photometer. The photometers described herein are simple, low cost, have a broad dynamic range and analyze multiple wavelengths. The devices, systems and methods of embodiments of the present invention have the advantages of not having any moving parts, allowing switching of light sources without using any mechanical system while still emitting light in the same optical pathway, and allowing for adjustment of intensities of multiple light sources and using them in any sequence with or without optical (e.g., interference) filters. No warm up is required before use of the photometer; nor is alignment of the light source and the detector required. No lamp switching between UV and visible lamps in required, as is in standard UV-Vis spectrophotometers. In addition, the photometers of embodiments of the present invention can be permanently sealed from dust, thus reducing strain on components and interference.

### I. Photometer

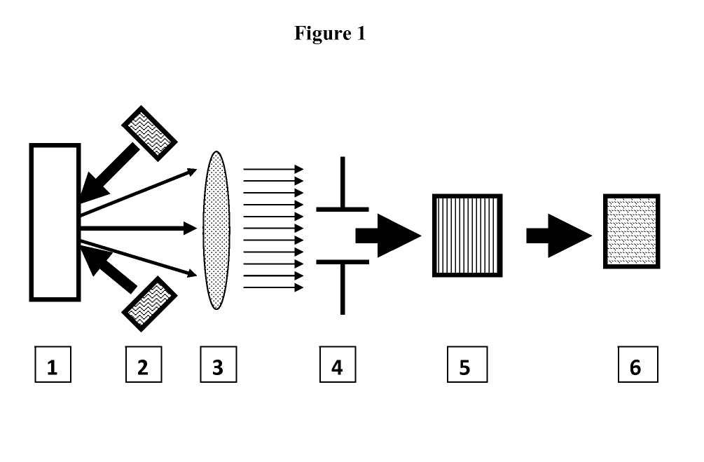

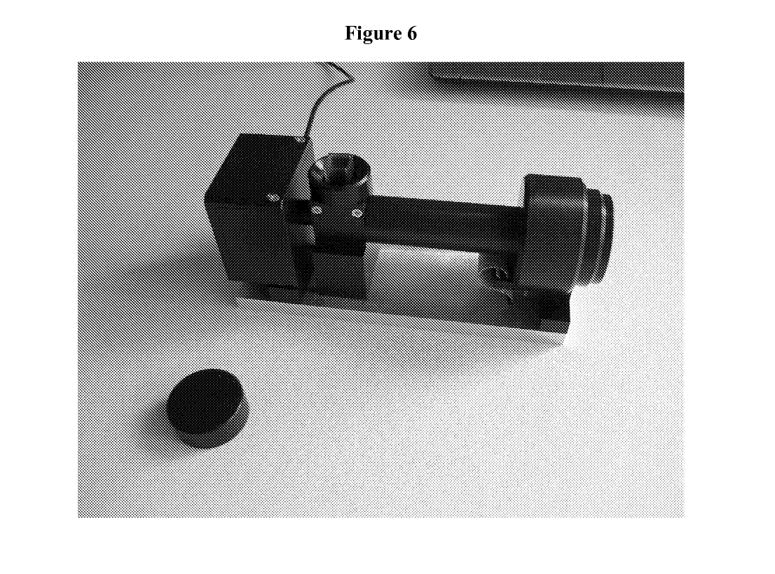

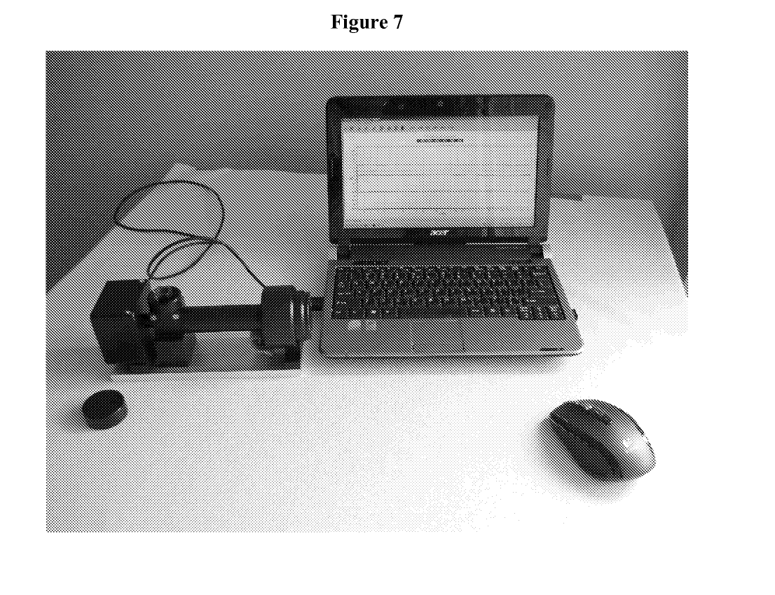

As described above, embodiments of the present invention provide a scattering light source photometer. Photographs of exemplary photometers and systems of embodiments of the present invention are shown in FIGS. 6 and 7. An exemplary photometer of embodiments of the present invention is shown in FIG. 1. The optical pathways from light sources (2) with optional optical (e.g., interference) filters is aligned to a light back-scattering material (1). Light then passes through a collimating lens (3) and optional slit (4) and through a sample holder (5) that comprises the sample to be analyzed. Light then passes into a detector (6).

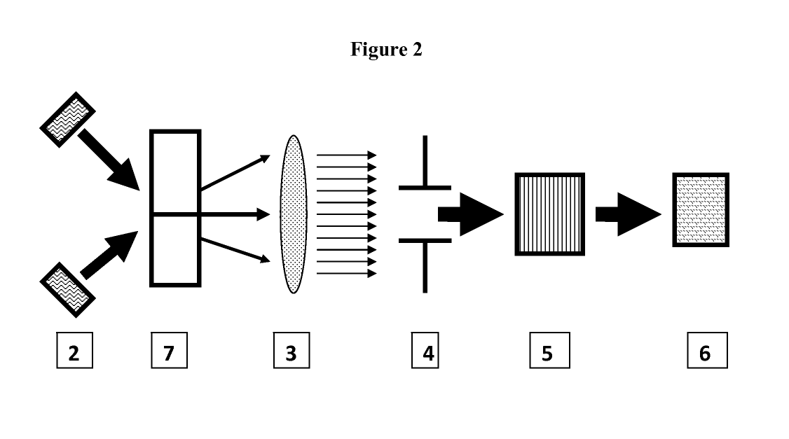

In a further embodiment (shown in FIG. 2), light sources (2) are placed behind (e.g., arranged in a circle) from a forward-scattering material (7). Light scattered after passing through the forward-scattering material (7) passes through collimating lens (3) and becomes parallel beams of light. The light then passes through a sample holder (5) holding the sample to be analyzed and into a detector (6).

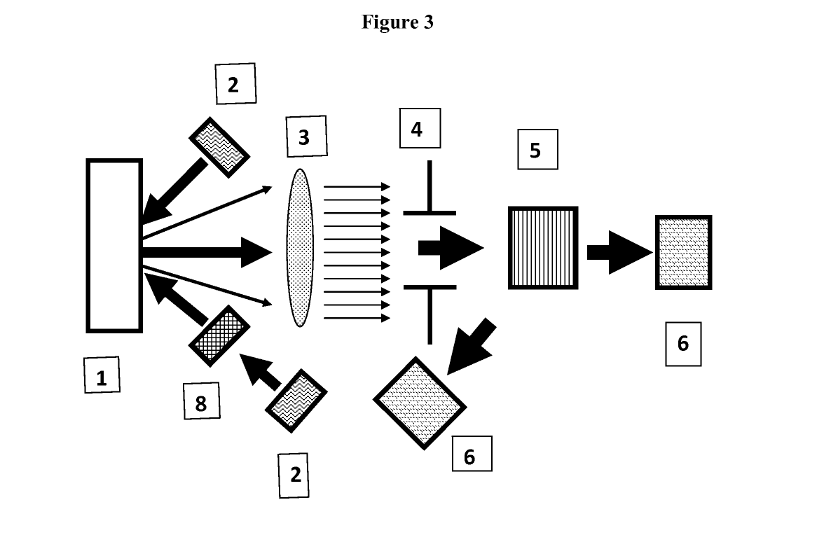

FIG. 3 shows further alternative embodiments of the photometers of embodiments of the present invention. An optional optical (e.g., interference) filter(s) (8) is shown placed in between the light source (2) and the back-scattering material (1) (or forward-scattering material (7) (not shown)). In addition, the detector (6) is shown in two possible locations. In some embodiments, the detector (6) is located at any position in between the two positions shown. In some embodiments, 2 or more detectors placed in different locations relative to the light beam are utilized. In some embodiments, the photometer further includes a control unit that turns on and off light emitting diodes in a required sequence at the same or modulated intensities. In some embodiments, each light emitting diode is controlled individually. In some embodiments, the diode control unit is synchronized with an analyzer detector.

In some embodiments, diodes are operated in a pulse mode. For example, in some embodiments, diodes are pulsed in cycles of “ON” and “OFF.” In some embodiments, the

“ON” and “OFF” modes are from 0.1 to 100 ms (e.g., 1 to 10 ms or 2 to ms). In some embodiments, multiple cycles (e.g., 10, 20, 30, 40, 50 or more) of “ON” and “OFF” are performed. In some embodiments, the readings from the entire cycle are averaged to obtain 1 data point. For example, in one exemplary embodiment, 30 cycles of 2 ms “ON” and 4ms “OFF” were performed. In some embodiments, diodes that do not exhibit a lag in turning off are utilized. The use of pulse mode provides the advantage of statistically more accurate results and allows one to compensate for electronic and accidental light background fluctuations.

In some embodiments, photometers comprise a single detector. The photometers of embodiments of the present invention are not limited to a particular detector type. Any suitable detector may be utilized. Exemplary detectors include, but are not limited to photodiodes or array of photodiodes (e.g., diode array) or a photomultiplier. Detectors may be placed at an angle of, for example greater than 0 to 180 degrees to the light beam, depending on the application. In some embodiments, multiple detectors (e.g., placed at different angles to the sample holder) are utilized in the same photometer.

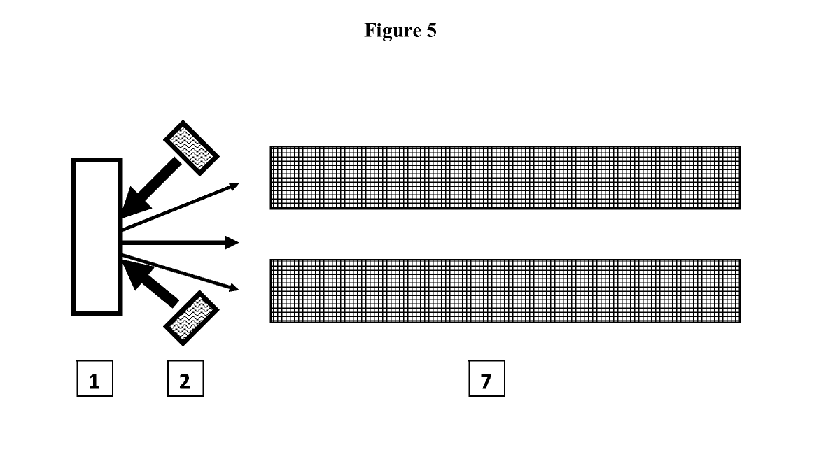

In some embodiments, photometers comprise multiple (e.g., two) optical pathways and detectors, forming a double beam photometer. Signal from both detectors can be compared, allowing subtraction of background or other signal. Because of the light scattering properties of the photometer, it is possible to utilize a single light source for the multiple beam photometer. An exemplary setup is shown in FIG. 5. FIG. 5 shows a single light sources (2) with optional optical (e.g., interference) filters is aligned to a light back-scattering material (1). Two optical path/detector components (7) are shown. Each optical path/detector component (7) comprises a collimating lens, and optional slit, sample holder and detector.

In some embodiments, the photometer further comprises a computer processor, computer memory and a display screen. In some embodiments, the microprocessor analyzes data and generates spectra and analysis results.

The light back-scattering material (1) is not limited to a particular light back-scattering material. In some embodiments, the back-scattering material is made out of or coated with a material with a reflectance coefficient close to 100% (e.g., at least 99%). Any matte, light-scattering (e.g., white colored) surface is suitable for use in embodiments of the present invention. In some embodiments, the material is FLUORILON-99W material (commercially available from, for example, Avian Technologies, Sunapee, N.H.).

Any suitable light forward-scattering material (1) may be utilized. In some embodiments, light forward-scattering films that break up and distribute light evenly are utilized. Examples include, but are not limited to, OPTIGRAFIX light diffuser films (commercially available from GRAFIX plastics, Cleveland, Ohio).

In some embodiments, an optical (e.g., interference) filter is placed between the light source and the scattering material. In some embodiments, optical filters block a specific wavelength or range of wavelengths of light. In some embodiments, optical filters remove infrared light.

The present invention is not limited to a particular light source. Exemplary light sources include, but are not limited to, one or more of light emitting diodes (LEDs), laser diodes or lamps. Light sources are commercially available from a variety of sources. Embodiments of the present invention utilize a plurality of LEDs or laser diodes (e.g., 2 or more, 4 or more, 6 or more, 10 or more, 12 or more, 24 or more, 48 or more, 50 or more, 100 or more, etc.). In some embodiments, multiple LEDs that each emit light of different wavelengths are used (e.g., allowing the photometer to measure absorbance at a plurality of different wavelengths).

In some embodiments, light output from one or more light sources are modified to modulate and/or normalize the light output at multiple wavelengths. This allows for use of multiple wavelengths of light in the same photometer with similar output intensities. In some embodiments, a plurality (e.g., 1 or more, 2 or more, 4 or more, 6 or more, etc.) of LEDs or laser diodes that emit the same wavelength are utilized at the same time or LEDs or laser diodes of varying voltage are utilized (e.g., different wavelengths of light are emitted at a higher of lower intensity). In some embodiments, LED or laser diodes are placed at varying distances from the scattering material in order to modulate intensity of signal. In some embodiments, photometers utilize a combination of LEDs or laser diodes that emit light of different wavelengths and multiple LEDs that emit the same wavelength. In some embodiments, one or more LEDs or laser diodes are used in combination with a lamp. Increase of illumination intensity in spectrum region(s), where detector sensitivity is low, allows one to obtain more balanced detector signal output throughout the whole instrument spectrum range.

The photometers of embodiments of the present invention utilize a power source for the LEDs, detector and controller, etc. Any suitable power source may be utilized, including but not limited to, 12V AC, 12V DC, and USB (e.g., using a convertor to convert 5V USB power to 12V).

### II. Uses

The photometers of embodiments of the present invention find use in a variety of applications. In some embodiments, the lightweight, low cost and durable photometers described herein find use in field or portable applications. In other embodiments, photometers find use in teaching laboratories (e.g., in a high school or university setting).

The photometers of embodiments of the present invention are suitable for measuring absorbance, turbidity (e.g., using nephelometry), polarimetry or fluorescence of any number of sample types. Examples include, but are not limited to, chemical testing, environmental testing, biological testing (e.g., testing for biological molecules), pharmaceutical testing, etc.

For example, in some embodiments, photometers described herein are utilized in the measurement of transmittance (e.g., absorbance or optical density) of solutions. In such embodiments, the detector is placed in line with the sample holder and measures light that passes through the sample in a straight line.

In some embodiments, photometers described herein are utilized in the measurement of turbidity of a suspension (e.g., particles in a liquid). In some embodiments, the detector is placed in line with the sample hold and measures light that passes through the sample in a straight line. In other embodiments, nephelometry is used to measure the reflection of light from particles in a suspension. In such embodiments, the detector is placed at an angle of greater than 0 to 90 degrees to the light beam.

In some embodiments, photometers described herein are utilized in the measurement of fluorescence of a solution, suspension, solid or powder. In such embodiments, the detector is placed at an angle of greater than 0 to 90 degrees to the light beam.

In some embodiments, the color or other property of a solid or powder sample is determined. In some embodiments, fluorescence measurements of a solid are utilized (e.g., with a detector at a greater than 0 to 90 degree angle to the sample). In other embodiments, reflectance of light of a solid is determined. In such embodiments, detectors are placed at an angle of greater than 0 to 90 (e.g., 45) degrees to the light beam.

In some embodiments, the photometers of embodiments of the present invention find use in kinetic studies. The detectors described herein are suitable for taking repeated measurement over time to generate data that can be analyzed to determine kinetics (e.g., reaction kinetics) (e.g., change in absorbance, turbidity, polarimetry or fluorescence of a solution over time).

In some embodiments, the photometers of embodiments of the present invention find use in flow cell applications (e.g., as flow cell detectors). In some embodiments, flow cell detectors analyze a plurality of distinct samples that do not mix. In other embodiments, flow cell detectors analyze a continuous flow of liquid or gas (e.g., samples from a chromatography apparatus). By passing through a flow cell of a photometer samples can be analyzed simultaneously at several wavelengths, excluding the necessity of rerunning the same sample several times.

One of ordinary skill in the art would recognize that other sample types and applications fall within the scope of embodiments of the present invention.

### EXPERIMENTAL

The following examples are provided in order to demonstrate and further illustrate certain preferred embodiments and aspects of the present invention and are not to be construed as limiting the scope thereof.

### EXAMPLE 1

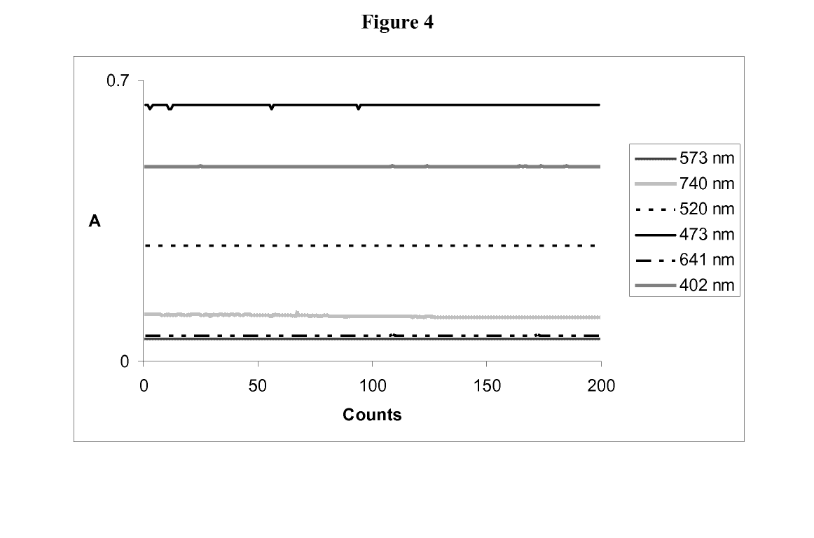

A photometer of embodiments of the present invention was used to take spectra of a didymium filter at 6 different wavelengths. Results are shown in FIG. 4. Results shown in FIG. 4 demonstrate stability of light intensities coming from 6 different LEDs over a period of 5 minutes.

Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the present invention.

We claim:

1. A photometer, comprising:
a) a plurality of light sources;
b) a light scattering material in the path of light emitted from said light source;
c) a focusing component in the path of light scattered from said light scattering material;
d) a sample holding component in the path of light focused by said focusing device; and
e) a detector configured to detect light that has interacted with and been altered by a sample in said sample handling component.

2. The photometer of claim 1, wherein said photometer further comprises an analysis component comprising a computer processor and computer display screen.

3. The photometer of claim 1, wherein said light source is selected from the group consisting of light emitting diodes (LEDs), laser diodes and lamps.

4. The photometer of claim 3, wherein said plurality of LEDs or laser diodes comprises at least two LEDs, wherein each of said at least two LEDS or laser diodes emits light of a different wavelength.

5. The photometer of claim 4, wherein said plurality of LEDs or laser diodes comprises at least six LEDs or laser diodes, wherein each of said at least six LEDS or laser diodes emits light of a different wavelength.

6. The photometer of claim 4, wherein said plurality of LEDs or laser diodes comprises at least twelve LEDs or laser diodes, wherein each of said at least twelve LEDS or laser diodes emits light of a different wavelength.

7. The photometer of claim 1, wherein said diodes are configured to pulse “ON” and “OFF.”

8. The photometer of claim 1, wherein said photometer comprises two or more optical pathways and detectors.

9. The photometer of claim 1, wherein said light scattering material is selected from the group consisting of back-scattering light material and forward-scattering light material.

10. The photometer of claim 9, wherein said back-scattering light material is made out of or coated with a material with a reflectance of at least 99%.

11. The photometer of claim 9, wherein said forward-scattering light material breaks up and distributes light evenly.

12. The photometer of claim 11, wherein said light is distributed in near Lambertian distribution.

13. The photometer of claim 1, wherein said focusing component is a collimating lens.

14. The photometer of claim 1, wherein said sample holding component is a cuvette holder.

15. The photometer of claim 1, wherein said detector is selected from the group consisting of a photo diode, a diode array, and a photomultiplier.

16. The photometer of claim 1, wherein said detector is placed at an angle of greater than 0 to 180 degrees relative to said light emitted from said light source.

17. A method, comprising
analyzing a sample with a photometer, said photometer comprising:
i) a plurality of light sources;
ii) a light scattering material in the path of light emitted from said light emitting diodes;
iii) a focusing component in the path of light scattered from said light scattering material;
iv) a sample holding component in the path of light focused by said focusing device; and
v) a detector configured to detect light that has interacted with and been altered by said sample
measuring the intensity of light that interacted with and been altered by said sample using said photometer.

18. The method of claim 17, wherein said sample is selected from the group consisting of chemical samples, environmental samples and biological samples.

19. The method of claim 17, wherein said sample is selected from the group consisting of a solution, a suspension and a solid.

20. The method of claim 17, wherein said measuring the intensity of light that has contacted said sample measures transmittance, reflectance or fluorescence of light.
